(19) United States
(12) Patent Application Publication
(10) Pub. No.: US 2014/0299314 A1
(43) Pub. Date: Oct. 9, 2014

(54) METHOD FOR THE USE OF NITRATES AND NITRATE REDUCING BACTERIA FOR MITIGATING BIOGENIC SULFIDE PRODUCTION

(71) Applicant: MULTI-CHEM GROUP, LLC, SAN ANGELO, TX (US)

(72) Inventors: Edward Corrin, Houston, TX (US); Michael Harless, Humble, TX (US)

(73) Assignee: MULTI-CHEM GROUP, LLC, SAN ANGELO, TX (US)

(21) Appl. No.: 13/857,723

(22) Filed: Apr. 5, 2013

(51) Int. Cl. C09K 8/532; E21B 43/16

(52) U.S. Cl. CPC C09K 8/532; E21B 43/16; C09K 2208/32
USPC 166/246; 507/201

(57) ABSTRACT

A method of controlling sulfides in a fluid including determining selected conditions of the fluid and selecting a nitrogen reducing bacteria (NRB) based on those conditions. The method further includes injecting an NRB into the fluid and injecting an inorganic nitrate into the fluid.

### BACKGROUND OF THE DISCLOSURE

1. Field of the Disclosure

The disclosure relates generally to the field of souring and microbiologically influenced corrosion in oil and gas production and completion fluids, as well as other industrial waters. More specifically the disclosure relates to methods for controlling souring and microbiologically influenced corrosion by deleterious microbes.

2. Background Art

Oil and gas production and completion fluids, as well as other industrial fluids, suffer corrosion, pipe necking (partial blockage) and scale buildup in pipes and pipelines. One source of these problems is microbially influenced corrosion (MIC) corrosion and bio-film blockages. Microbes may also negatively affect oil and natural gas recover through bacterial fouling of the water needed to hydrofracture (“frac”) reservoir rock or to “water-flood,” to increase production of oil and gas. One particular type of microbe, sulfate reducing bacteria (SRB) can contaminate or “sour” the reservoir by producing hydrogen sulfide (H₂S). SRB may produce toxic and flammable H₂S, which may shorten the lifetime of an piping and tankage, and introduce additional safety risks from drill rig to refinery. Acid producing bacteria (APB) produce acids, including sulfuric acid, which lead to additional corrosion. SRB and APB may have the same effects in other oil and gas completion fluids, as well as other industrial fluids.

SRB may also present problems in subterranean formations, such as during fracturing, water floods, and production. increased flow of hydrocarbons. Fluids that enter the subterranean formation may not be initially recovered, but, instead, remain in the formation. The unrecovered fracturing fluid in the formation may provide a fertile breeding ground for the SRB can be detrimental to both the recovery of the hydrocarbon and the hydrocarbon itself. SRB act to reduce sulfates to sulfides which are detrimental to both the formation itself, as well as to the hydrocarbon recovered. For instance, the SRB may create sludge or slime, which can reduce the porosity of the formation and thereby impede hydrocarbon recovery. SRB may also produce hydrogen sulfide which may sour the hydrocarbon, as well as cause corrosion in metal tubulars and surface equipment.

### SUMMARY

In one embodiment of the present disclosure, a method of controlling sulfides in a fluid is disclosed. The method includes determining selected conditions of the fluid and selecting a nitrogen reducing bacteria (NRB) based on those conditions. The method further includes injecting an NRB into the fluid and injecting a nitrite or nitrate into the fluid.

In another embodiment of the present disclosure, a method of controlling sulfides in a subterranean formation is disclosed. The method includes selecting a fluid to be injected into the subterranean formation and determining selected conditions of the fluid in the subterranean formation. The method further includes selecting a nitrogen reducing bacteria NRB based on those conditions. In addition, the method includes injecting an NRB into the fluid and injecting a nitrite or nitrate into the fluid.

### DETAILED DESCRIPTION

The following disclosure provides many different embodiments, or examples, for implementing different features of various embodiments. Specific examples of components and arrangements are described below to simplify the present disclosure. These are, of course, merely examples and are not intended to be limiting.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

In the present disclosure, inorganic nitrates or inorganic nitrites are injected into the oil and gas and other industrial fluids in conjunction with nitrate-reducing bacteria or nitrate reducing sulfide oxidizing bacteria (NRSOB) (generically, “NRB”) as a control mechanism for SRB in place of or in conjunction with a traditional biocide. Molybdates also may be used in conjunction with the inorganic nitrates as a control mechanism for SRB.

SRB and NRB typically compete for the same non-polymer carbon source (such as acetates) present in the subterranean formation or industrial fluid needed for growth of bacteria. By increasing the growth rate of the NRB in comparison to the SRB, the NRB may out compete the SRB in consumption of the available non-polymer carbon source, depriving the SRB of its ability to grow and create the undesirable sulfides. Further, by inhibiting the growth rate of the SRB, the NRB may predominate, again out competing the SRB for the available non-polymer carbon in the subterranean formation or industrial fluid.

NRB are often indigenous in the subterranean formation or already present in the fluid and simple addition of the inorganic nitrate may be adequate to stimulate the NRB to outcompete SRB for the non-polymer carbon source. However, in certain circumstances, such as when the indigenous amount of NRB is inadequate, absent, or less active than the competing SRB, it may be necessary to supplement the indigenous NRB with suitable additional NRB. Thus, in certain embodiments of the present disclosure, NRB are added to the oil and gas or industrial fluid.

Suitable NRB may include any type of microorganism capable of performing anerobic nitrate reduction, such as heterotrophic nitrate-reducing bacteria, and nitrate-reducing sulfide-oxidizing bacteria. These may include, but is not limited to, Campylobacter sp. Nitrobacter sp., Thiobacillus sp., Nitrosomonas sp., Thiomicrospira sp., Sulfurospirillum sp., Thauera sp., Paracoccus sp., Pseudomonas sp., Rhodobacter sp., or Specific examples include, but are not limited to, Nitrobacter vulgaris, Nitrosomonas europea, Pseudomonas stutzeri, Pseudomonas aeruginosa, Paracoccus denitrificans , Sulfurospirillum deleyianum, and Rhodobacter sphaeroides.

In certain embodiments of the present disclosure, the NRB is specifically selected for the target oil and gas fluid, subterranean formation or other industrial fluid, i.e., the selection process for the NRB includes identification of strains that proliferate and metabaolize under the measured conditions of the particular system for which the NRB will be applied. These selection criteria include, but are not limited to, system temperatures, pressures, total dissolved solids concentration, anion and cation concentrations, dissolved gas concentrations, available organic carbon electron donors, and pH. The NRB that are optimized to metabolize under the system conditions may be selected from a library of existing NRB strains or may be cultured from the system to be treated or a similar system.

The amount of NRB injected into the subterranean formation or the oil and gas or other industrial fluid may depend upon a number of factors including the amount of SRB expected, as well as any biocide that may be present. When injected into subterranean formation, the permeability and porosity of the subterranean formation may be considered as well. In certain embodiments of the present disclosure, the amount of NRB injected into the fluid is between 1 and 10⁸ bacteria count/ml of the fluid, or alternatively between 10¹ and 10⁴ bacteria count/ml of the fluid.

NRB of the present disclosure may convert inorganic nitrates to nitrites. In addition, in certain embodiments of the present disclosure, the NRB of the present disclosure also may convert nitrites to ammonia. In certain other embodiments of the present disclosure, the NRB of the present disclosure may convert ammonia to nitrogen gas. Thus, in addition to adding nitrates to the fracturing fluid, in certain embodiments of the present disclosure, inorganic nitrites may also be added to the fracturing fluid. It has further been found that nitrites may scavenge hydrogen sulfide, further reducing the souring of the hydrocarbon produced. Inorganic nitrites include, for instance sodium nitrite and potassium nitrite and are typically added in the range of between about 5 and 100 ppm by weight of the fracturing fluid.

Organic and inorganic nitrates and nitrites serve to stimulate the growth of the NRB present in the certain oilfield and industrial water systems, thus outcompeting SRB present in the formation. Organic and inorganic nitrates or inorganic nitrites may be used injected into the certain oilfield and industrial water systems. Inorganic nitrates and inorganic nitrites available for use in the present disclosure include, for instance, potassium nitrate, potassium nitrite, sodium nitrate, sodium nitrite, ammonium nitrate, and mixtures thereof. These organic and inorganic nitrates and inorganic nitrites are commonly available, but are non-limiting and any appropriate nitrate or nitrite may be used.

The amount of organic or inorganic nitrate or nitrite used is dependent upon a number of factors, including the amount of sulfate and/or organic acids present in the oilfield and industrial water systems, and the expected amount of NRB needed to counteract the SRB. In certain embodiments of the present disclosure, the concentration of organic or inorganic nitrate or nitrite in the oilfield or industrial water systems may be less than 2000 ppm by weight of the water solution, alternatively 500 to 1600 ppm by weight or alternatively between about 900 and 1100 ppm by weight when applied using a batch application method. When applied through continuous operation, the concentration of the organic or inorganic nitrate or nitrite may be less than 500 ppm by weight, alternatively between 10 and 500 ppm, or alternatively between 10 and 100 ppm.

In addition to stimulating the NRB to out compete the SRB, it may be desirable to introduce additional SRB inhibitors in certain embodiments of the present disclosure together with the inorganic nitrates. Examples of SRB inhibitors suitable for the present disclosure are 9,10-anthraquinone, molybdates and molybdate salts, such as sodium molybdate and lithium molybdate, although any SRB inhibitor may be used in concentrations where the molybdates do not unduly affect the ability of the NRB to otherwise out compete the SRB. In certain embodiments of the present disclosure, molybdate is added to the fluid in the range of 5 to about 100 ppm by weight of fluid.

In certain embodiments, biocides may be used in the oil and gas and other industrial waters in conjunction with the phage and NRB. Prior to the application of the NRB, the system may be pre-treated with a biocide to reduce the existing bacterial populations, including the SRB, to allow the NRB to competitively exclude the SRB population in the fluid or subterranean formation. The NRB may be applied after the biocide concentration has been reduced to where the biocide no longer interferes or minimally interferes with the growth of the NRB. With short acting biocides, such as bleach, chlorine dioxide, DBNPA, or peracetic acid, the injection of the NRB may be after the biocide has decomposed or deteriorated. With longer acting biocides, such as a quaternary amine compound, THPS, dimethyloxazolidine, or aldehyde-based biocides, including, but not limited to gluteraldhye, it may be necessary to neutralize the biocide prior to introducing the NRB. In certain embodiments, the biocide may be compatible with the NRB and it may be possible to inject the NRB while the biocide is active.

The NRB may be injected into the fluid or subterranean formation in conjunction with or separately from the nitrate source. The injection may be continuous, batch, pulse or slug.

This disclosure will now be further illustrated with respect to certain specific examples which are not intended to limit the disclosure, but rather to provide more specific embodiments as only a few of many possible embodiments.

### EXAMPLE 1

A library of NRBs may be tested under expected conditions of a subterranean formation in conjunction with the carrier fluid for the NRB, such as a fracturing fluid. Those conditions include system temperatures, pressures, total dissolved solids concentration, anion and cation concentrations, dissolved gas concentrations, available organic carbon electron donors, and pH. A suitable NRB may then be chosen and added to the fracturing fluid in sufficient amounts to bring the concentration of the NRB to about 10² bacteria count/ml fracturing fluid. The fracturing fluid may then be prepared with sufficient sodium nitrate to bring the sodium nitrate concentration in the fracturing fluid to about 800 ppm by weight. The fracturing fluid may then be injected into a hydrocarbon-producing, subterranean formation.

### EXAMPLE 2

A fracturing fluid may be prepared in accordance with Example 1. Sodium molybdate may be added to the fracturing fluid in sufficient amount to bring the concentration of the sodium molybdate to 50 ppm by weight of fracturing fluid.

While the foregoing is directed to embodiments, versions and examples of the present disclosure, which are included to enable a person of ordinary skill in the art to make and use the disclosures when the information in this patent is combined with available information and technology, the disclosure is not limited to only these particular embodiments, versions and examples. Also, it is within the scope of this disclosure that the aspects and embodiments disclosed herein are usable and combinable le with every other embodiment and/or aspect disclosed herein, and consequently, this disclosure enabling for any and all combinations of the embodiments and/or aspects disclosed herein. Other and further embodiments, versions and examples of the disclosure may be devised without departing from the basic scope thereof and the scope thereof is determined by the claims that follow.

What is claimed is:

1. A method of controlling sulfides in a fluid, comprising:
determining selected conditions of the fluid
selecting a nitrogen reducing bacteria (NRB) based on those conditions
injecting an NRB into the fluid; and
injecting a nitrate or nitrite into the fluid.

2. The method of claim 1 wherein the inorganic nitrate is selected from the group consisting of potassium nitrate, potassium nitrite, sodium nitrate, sodium nitrite, ammonium nitrate, and mixtures thereof.

3. The method of claim 1 wherein the NRB is selected from a library.

4. The method of claim 1 wherein the NRB is selected from the group consistent of Campylobacter sp. Nitrobacter sp., Nitrosomonas sp., Thiomicrospira sp., Sulfurospirillum sp., Thauera sp., Paracoccus sp., Pseudomonas sp., Rhodobacter sp., Desulfovibrio sp., and mixtures thereof.

5. The method of claim 4 wherein NRB is Nitrobacter vulgaris, Nitrosomonas europea, Pseudomonas stutzeri, Pseudomonas aeruginosa, Paracoccus denitrificans, Sulfurospirillum deleyianum, and Rhodobacter sphaeroides.

6. The method of claim 1 further comprising:
injecting a molybdate or molybdate salt into the fluid.

7. The method of claim 6 wherein the molybdate salt is selected from the group consisting of sodium molybdate, lithium molybdate, and mixtures thereof.

8. The method of claim 1 wherein the selected conditions are selected from the group consisting of fluid temperatures, pressures, total dissolved solids concentration, anion and cation concentrations, dissolved gas concentrations, available organic carbon electron donors, pH, and combinations thereof.

9. A method of controlling sulfides in a subterranean formation, comprising:
selecting a fluid to be injected into the subterranean formation
determining selected conditions of the fluid in the subterranean formation
selecting a nitrogen reducing bacteria NRB based on those conditions;
injecting an NRB into the fluid; and
injecting a nitrite or nitrate into the fluid.

10. The method of claim 9, wherein the inorganic nitrate is injected in sufficient quantities to achieve a concentration of inorganic nitrate of between 500 ppm and 1000 ppm by weight of fluid.

11. The method of claim 9, wherein NRB is injected in sufficient quantities to achieve a concentration of NRB between 10¹ and 10⁴ bacteria count/ml of the fluid.

12. The method of claim 9 further comprising prior to the step of injecting an NRB into the fluid:
injecting a biocide into the subterranean formation.
